(19) United States
(12) Patent Application Publication
(10) Pub. No.: US 2015/0111092 A1
(43) Pub. Date: Apr. 23, 2015

(54) SHRINK FILM

(71) Applicant: CCL Label, Inc., Framingham, MA (US)

(72) Inventors: Paul Janousek, Simpsonville, SC (US); Vadim Zaikov, Perry, OH (US); Farid Ghiam, Beachwood, OH (US); Robert Quattlebaum, Tryon, NC (US); Walter Mueller, Tryon, NC (US)

(21) Appl. No.: 14/397,100

(22) PCT Filed: Apr. 26, 2013
(86) PCT No.: PCT/US2013/038355

§ 371 Date: Oct. 24, 2014

Related U.S. Application Data
(60) Provisional application No. 61/638,697, filed on Apr. 26, 2012.

(51) Int. Cl. B32B 27/08; B32B 1/02; H01M 2/02; B65D 75/00; B32B 27/32; B32B 27/30; B29D 99/00; B32B 27/36; B29D 7/01

(52) U.S. Cl. CPC B32B 27/08; B32B 27/36; B32B 1/02; H01M 2/0287; B29D 7/01; B32B 27/32; B32B 27/308; B32B 27/306; B29D 99/006; B65D 75/002; H01M 2/026; H01M 2/0262; H01M 2/0267; B32B 2250/05; B32B 2250/24; B32B 2250/242; B32B 2250/246; B32B 2250/40; B32B 2323/046; B32B 2323/10; B32B 2331/04; B32B 2333/08; B32B 2367/00; B32B 2439/40; B29L 2009/00
USPC 429/163; 428/516; 428/483; 428/35.7; 264/173.14

(57) ABSTRACT

A multi-layer shrink film. The shrink film can exhibit a significant amount of shrink within a certain temperature range that is above the onset temperature of the film. The film can exhibit a shrinkage that is at least about 50% of the total shrink within a temperature range T1 above the onset temperature of the film. In one aspect, the shrink film comprises a core layer and skin layers disposed about opposite surfaces of the core layer, and tie layers disposed between the core and the skin layers, the skin layers individually comprising a polyester, e.g., a glycol-modified polyester, and the tie layers individually comprising an anhydride modified material.

### CROSS-REFERENCE TO RELATED APPLICATION

The present application claims the benefit of U.S. Provisional Patent Application No. 61/638,697 filed Apr. 26, 2012, which is incorporated herein by reference in its entirety.

### FIELD

The present invention relates to shrink films and provides shrink films having excellent shrink properties. The films can include a polyester (e.g., a glycol-modified polyethylene terephthalate) material in an outer layer of the film. The shrink films can be used in a variety of applications including for encapsulating cylindrical articles including bottles, batteries, etc.

### BACKGROUND

Shrink film has been used for years to encapsulate articles. The shrink film must be able to shrink sufficiently to provide a smooth consistent coating. Previously, shrink films have been made from polyolefins and polyolefin blends and used extensively in the food and packaging business to protect and preserve articles such as food. One problem with polyolefin and polyolefin film blends is the difficulty of printing on the film. For printing to be successful, the films must provide a surface that will accept printing. Additionally the films must have sufficient tensile modulus to withstand the rigors of the printing process. Some polyolefin films do not have the tensile strength to withstand gravure printing. Some polyolefin shrink films may be able to withstand gravure printing but may still exhibit poor performance when placed on the article to be encapsulated, e.g., a battery.

Polyvinyl chloride (PVC) films provide acceptable shrinkages of about 40% to 45%. However, PVC shrink films have a problem with heat stability. Often, after the shrink film has been formed, the film may be exposed to elevated temperatures, such as in transport, which may cause the film to shrink prematurely. Another problem with PVC shrink films is concern over the environmental impact of PVC film, which forms harmful dioxins when incinerated. Concern regarding potentially adverse effects of halogens on the ozone layer has lead to efforts to provide halogen free shrink films.

Batteries are typically encapsulated by shrink films. The film must shrink sufficiently to encase the battery. A problem with encapsulating batteries and other cylindrical article is end puckering, which occurs when the shrink film does not shrink sufficiently to provide a smooth encapsulating film at the ends of the battery. The film folds over itself and forms a “pucker.” This puckering is unacceptable to consumers and, therefore, also to the manufacturer.

Battery encapsulating is done at very high speeds. The speed of the labeling is often more that 700 labels applied per minute. It is difficult for typical shrink film labels to work under such high speed conditions.

### SUMMARY

The present invention provides, in one aspect, a shrink film exhibiting excellent shrink properties. In one aspect, the present invention provides a shrink film exhibiting a relatively high shrink percent in at least one direction within a certain temperature range (which may be referred to as the “shrink window”) above the onset temperature of the film. In one embodiment, the shrink film exhibits a significant shrinkage relative to the total shrink of the film within the shrink window.

In one embodiment, the present invention provides a shrink film comprising a plurality of layers and exhibiting a shrink onset temperature, wherein the film exhibits a total shrink and at least about 50% of the total shrink occurs within a temperature range T1 above the onset temperature of the film. In one embodiment, the shrink film exhibits a shrinkage of from about 50% to about 90% of the total shrink within the temperature range T1. In one embodiment, the shrink film exhibits a shrinkage of from about 60% to about 80% of the total shrink within the temperature range T1.

In one embodiment, the present invention provides a shrink film comprising a plurality of layers and exhibiting an onset shrinkage temperature, wherein the film exhibits a shrink in at least one direction of at least 30% within a temperature of about 15° C. to about 40° C. above the onset temperature. In one embodiment, the film exhibits a shrink of about 30% to about 50% within a temperature of about 15° C. to about 40° C. above the onset temperature. In one embodiment, the film exhibits a shrink of about 30% to about 50% within a temperature of about 40° C. above the onset temperature. In one embodiment, the film exhibits a shrink of about 30% to about 50% within a temperature of about 30° C. above the onset temperature. In one embodiment, the film exhibits a shrink of about 30% to about 50% within a temperature of about 15° C. above the onset temperature.

In another embodiment, the present invention provides a shrink film comprising a core layer having an upper surface and a lower surface; a first skin layer disposed about the upper surface of the core layer; a second skin layer disposed about the lower surface of the core layer; a first tie layer disposed between the first skin layer and the upper surface of the core layer; and a second tie layer disposed between the second skin layer and the lower surface of the core layer, wherein the first and second skin layers individually comprise a polyester material, and the tie layers individually comprise a molecular structure with a pendant or terminal group capable of anchoring dissimilar materials. In one embodiment, the tie layers individually comprise an anhydride modified material, a methoxysilane modified material, etc.

In one embodiment, the skin layers individually comprise a glycol-modified polyester. In one embodiment, the skin layers individually comprise PET, PETG or a combination thereof.

In one embodiment, the core layer comprises a polyolefin; the skin layers individually comprise a glycol-modified polyester; and the tie layers individually comprise an anhydride modified ethylene methacrylate material.

In one aspect, the present invention provides a method of making a shrink film comprising forming a plurality of film layers to provide a film structure having a core layer having an upper surface and a lower surface; a first skin layer disposed about the upper surface of the core layer; a second skin layer disposed about the lower surface of the core layer; a first tie layer disposed between the first skin layer and the upper surface of the core layer; and a second tie layer disposed between the second skin layer and the lower surface of the core layer, wherein the first and second skin layers individually comprise a polyester, and the tie layers individually comprise an anhydride modified material.

A shrink film in accordance with aspects of the invention can provide a relatively low cost film with excellent properties and print capability. The present shrink films can exhibit excellent properties including, but not limited to, good MD shrink, low TD growth, a high modulus, and low shrink force.

### BRIEF DESCRIPTION OF THE DRAWINGS

Embodiments and aspects of the invention are illustrated with reference to the following drawings.

FIG. 1 illustrates a side view of a five-layered shrink film in accordance with an embodiment of the present invention; and

FIG. 2 illustrates a side view of a seven-layered shrink film in accordance with an embodiment of the present invention.

The drawings illustrate aspects of the invention and are not intended to limit the invention. Further aspects and embodiments of the invention are understood in reference to the following detailed description.

### DETAILED DESCRIPTION

A shrink film suitable for use as a shrink label to cover and encapsulate a variety of articles comprises a core and outer layers disposed about the core. The shrink films are useful in a variety of applications including, but not limited to, encapsulating cylindrical articles.

A shrink film in accordance with the present invention comprises a multi-layer film. The film can exhibit excellent shrink properties. In one embodiment, the film can exhibit a shrinkage of at least 30% within a temperature range of 15° C. to about 40° C. above the shrink onset temperature of the film. In one embodiment, the shrink film is a multi-layer film comprising at least five layers: a core layer having an upper and lower surface, a first skin layer disposed over the upper surface of the core layer, a second skin layer disposed over the lower surface of the core layer, and a tie layer disposed between the core layer and the skin layers. In one embodiment, the shrink film is a five-layered film. In another embodiment, the core layer can be a multilayered construction having two, three, or more layers. In one embodiment, the shrink film is a seven-layered film having a three-layered core structure.

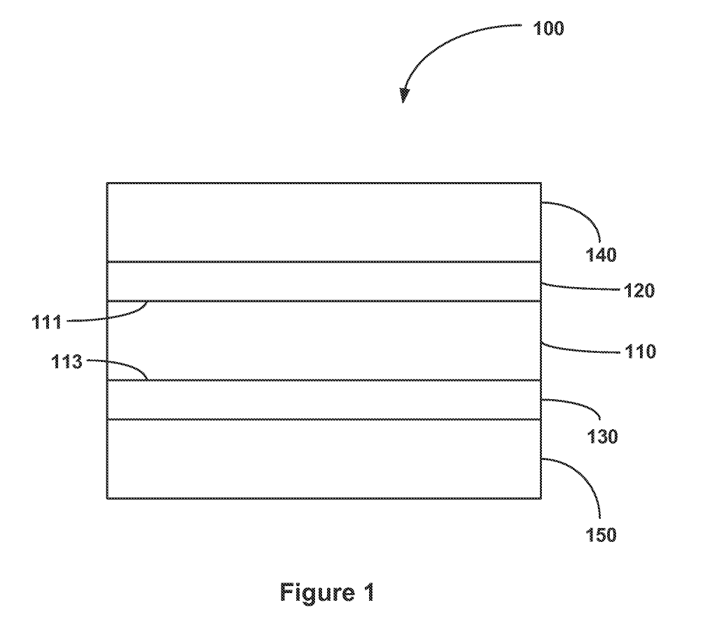

FIG. 1 illustrates an embodiment of a five-layered shrink film. In FIG. 1, the shrink film 100 comprises a core layer 110, skin layers 140 and 150 disposed about opposite surfaces of the core layer 110, a tie layer 120 disposed between the core layer 110 and the skin layer 140, and a tie layer 130 disposed between the core layer 110 and the skin layer 150. As shown in FIG. 1, the tie layer 120 is disposed on a first (upper) surface 111 of core layer 110, and the tie layer 130 is disposed on a second (lower) surface 113 of core layer 110.

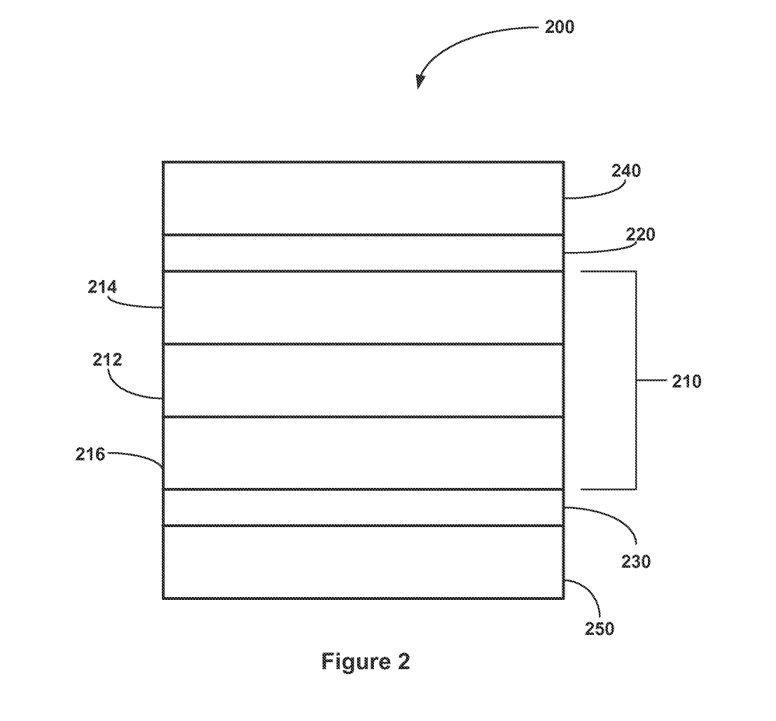

FIG. 2 illustrates an embodiment of a seven-layered shrink film. In FIG. 2, the shrink film 200 comprises a core layer 210, skin layers 240 and 250 disposed about opposite surfaces of the core layer 210, a tie layer 220 disposed between the core layer 214 and the skin layer 240, and a tie layer 230 disposed between the core layer 216 and the skin layer 250. In FIG. 2, the core layer 210 is a multi-layered core comprising a central core layer 212 and outer core layers 214 and 216 disposed on opposite surfaces of the central core layer 212. As shown in FIG. 2, the tie layer 220 is disposed on a first (upper) surface of core layer 210 formed by a surface of layer 214, and the tie layer 230 is disposed on a second (lower) surface of core layer 210 formed by a surface of layer 216.

It will be appreciated that the shrink films are not limited to the embodiments shown in FIG. 1 or 2 and may comprise other layers as desired for a particular purpose or intended use.

### Core Layer

The core layer comprises a resin material. The resin material for the core layer can be chosen from an amorphous material, a semi-crystalline material, or a combination thereof. In one embodiment, the core layer comprises an amorphous resin material. In another embodiment, the core layer comprises a semi-crystalline material. The semi-crystalline material can have a crystallinity of about 1% to about 80%. Examples of suitable materials for the core layer include, but are not limited to, polyolefin materials, polyester materials, polylactic acid, polystyrene, etc. Polyester materials can include regular polyester materials, glycol-modified polyester materials, and combinations thereof. Polyester materials are further described in greater detail herein with respect to the skin layers. It will be appreciated that the materials suitable for the skin layer can be employed in the core layer.

In one embodiment, the core layer comprises a polyolefin resin. Examples of suitable polyolefin resins include, but are not limited to, homopolymers such as polyethylenes (PEs), polypropylenes (PPs), polybutylenes, and polymethylpentenes (PMPs); olefin copolymers including alpha-olefin copolymers, random copolymers such as, for example, ethylene-alpha-olefin random copolymers and propylene-alpha-olefin random copolymers; and amorphous (noncrystalline) cyclic olefin polymers such as copolymers between a cyclic olefin and an alpha-olefin (e.g., ethylene or propylene) and graft-modified derivatives thereof, ring-opened polymers of cyclic olefins and hydrogenated products thereof, and graft-modified products thereof. In one embodiment, the core layer comprises a polyolefin having a low density or low specific gravity such as, for example low-density polyethylenes (LDPEs), linear low-density polyethylenes (LLDPEs), and metallocene-catalyzed LLDPEs (mLLDPEs), as well as polypropylenes and propylene random copolymers such as propylene-alpha-olefin copolymers. In one embodiment the polyolefin resins can have a density of 0.80 to 0.95 g/cm³. Specific examples of useful polyolefins include those prepared using a Ziegler-Natta catalysts or a metallocene catalysts and LLDPEs available from Exxon.

The core can comprise a single type of polyolefin, a blend of similar types of polyolefins (e.g., a blend of different grades of LLDPE's), or a blend of different classes of polyolefins. In one embodiment, the core can comprise a blend of polyolefins such as a blend of a polyethylene (homopolymer) and an polyolefin-copolymer, e.g., an ethylene copolymer. In another embodiment, the core can comprise a blend of polyethylenes of different densities. For example, the blend can comprise two or more polyethylenes chosen from very low density polyethylenes (VLDPE), low density polyethylenes (LDPE), medium density polyethylenes (MDPE), linear low density polyethylenes (LLDPE), and high density polyethylenes (HDPE). In one embodiment, the core layer (e.g., the central core layer such as core layer 110 or 212 of FIGS. 1 and 2) comprises a LLDPE; in another embodiment, the core layer comprises a blend of a LLDPE and a HDPE. In one embodiment comprising a multi-layer core (such as an embodiment illustrated in FIG. 2), the center core (e.g., core layer 212) can comprise LLDPE, and the outer core layers can comprise a LLDPE, a MDPE, a HDPE, or a blend of two or more thereof.

The core layer can comprise an alpha-olefin copolymer such as, for example, an ethylene-alpha-olefin copolymer or a propylene-alpha-olefin copolymer. Exemplary alpha-olefins for use as a copolymerizable component (comonomer) in such copolymers include ethylene or propylene and alpha-olefins having about four to twenty carbon atoms, such as 1-butene, 1-pentene, 4-methyl-1-pentene, 1-hexene, 1-heptene, 1-octene, 1-nonene, 1-decene, etc. Each of different copolymerizable components may be used alone or in combination.

The core layer can also comprise recycled resin material. In one embodiment, the core layer can comprise up to 20% by weight of recycled material. In one embodiment, the core layer comprises recycled polyolefinic material.

In one embodiment, the core layer can be treated to cross-link the core material. Cross-linking can be accomplished by inclusion of a chemical cross-linking agent into the core composition, irradiating the core layer, or both.

The core layer comprises a resin material. The resin material for the core layer can be chosen from an amorphous material, a semi-crystalline material, or a combination thereof. In one embodiment, the core layer comprises an amorphous resin material. In another embodiment, the core layer comprises a semi-crystalline material. The semi-crystalline material can have a crystallinity of about 1% to about 80%. Examples of suitable materials for the core layer include, but are not limited to, polyolefin materials, polyester materials, polylactic acid, polystyrene, etc. Polyester materials can include regular polyester materials, glycol-modified polyester materials, and combinations thereof. The polyolefin materials suitable for the core material can also be included in the skin layers.

### Skin Layers

In one embodiment, the skin layers individually comprise a polyester material. A polyester material can comprise a polymer made by polymerization of a dicarboxylic acid component and a difunctional alcohol monomer. In one embodiment, the polyester resin can be a “regular polyester resin material” comprising a single repeating unit. In one embodiment, the polyester resin may be a “glycol-modified polyester material” comprising a polymer made by polymerization of a dicarboxylic acid with (1) a difunctional alcohol monomer other than ethylene glycol, or (2) two or more difunctional alcohol monomers, one of which may be ethylene glycol. In one embodiment, a glycol-modified polyester may comprise a polymer made by polymerization of a dicarboxylic acid with two or more difunctional alcohols, at least one of which is ethylene glycol.

The difunctional carboxylic acid may be an aromatic dicarboxylic acid. Examples of aromatic dicarboxylic acids suitable for use in the modified polyester resin include, but are not limited to, terephthalic acid, isophthalic acid, phthalic acid, 2,5-dimethylterephthalic acid, 5-t-butylisophthalic acid, 4,4′-biphenyldicarboxylic acid, trans-3,3′-stilbenedicarboxylic acid, trans-4,4′-stilbenedicarboxylic acid, 4,4′-dibenzyldicarboxylic acid, 1,4-naphthalenedicarboxylic acid, 1,5-naphthalenedicarboxylic acid, 2,3-naphthalenedicarboxylic acid, 2,6-naphthalenedicarboxylic acid, 2,7-naphthalenedicarboxylic acid, 2,2,6,6-tetramethylbiphenyl-4,4′-dicarboxylic acid, 1,1,3-trimethyl-3-phenylindene-4,5-dicarboxylic acid, 1,2-diphenoxyethane-4,4′-dicarboxylic acid, diphenyl ether dicarboxylic acid, 2,5-anthracenedicarboxylic acid, 2,5-pyridinedicarboxylic acid, derivatives thereof, or a combination of two or more thereof. In one embodiment, the aromatic dicarboxylic acid component is terephthalic acid.

A glycol-modified polyester resin for use herein may also contain one or more aliphatic or alicyclic difunctional dicarboxylic acids as copolymerization components. Non-limiting examples of suitable aliphatic dicarboxylic acid components include oxalic acid, malonic acid, succinic acid, glutaric acid, adipic acid, pimelic acid, suberic acid, azelaic acid, sebacic acid, undecanedioic acid, dodecanedioic acid, tridecanedioic acid, tetradecanedioic acid, pentadecanedioic acid, heptadecanedioic acid, octadecanedioic acid, nonadecanedioic acid, icosanedioic acid, docosanedioic acid, 1,12-dodecanedionoic acid, and derivatives of thereof. Non-limiting examples of suitable alicyclic dicarboxylic acid components include 1,3-cyclopentanedicarboxylic acid, 1,2-cyclohexanedicarboxylic acid, 1,3-cyclohexanedicarboxylic acid, 1,4-cyclohexanedicarboxylic acid, 1,4-decahydronaphthalenedicarboxylic acid, 1,5-decahydronaphthalenedicarboxylic acid, 2,6-decahydronaphthalenedicarboxylic acid, and substitution derivatives of them. It will be appreciated that the copolymerization components can be used alone or in combination.

As previously described, a glycol-modified polyester comprises a component derived from a difunctional alcohol. In one embodiment, a glycol-modified polyester comprises a component derived from a single type of difunctional alcohol other than ethylene glycol. In another embodiment, a glycol-modified polyester comprises components derived from two or more difunctional alcohols where one of the two or more monomers may be ethylene glycol.

The difunctional alcohols used to form a regular polyester or a glycol-modified polyester may include, for example, aliphatic diols, alicyclic diols, aromatic diols, or combinations of two or more thereof. Non-limiting examples of suitable aliphatic diols include ethylene glycol (when used in conjunction with at least one of the difunctional alcohol), diethylene glycol, 1,2-propanediol, 1,3-propanediol, 1,3-butanediol, 1,4-butanediol, 1,5-pentanediol, 2,2-dimethyl-1,3-propanediol (neopentyl glycol), 1,6-hexanediol, 2-ethyl-2-methyl-1,3-propanediol, 2,2-diethyl-1,3-propanediol, 1,8-octanediol, 2-ethyl-2-butyl-1,3-propanediol, 2-ethyl-2,4-dimethyl-1,3-hexanediol, 1,10-decanediol, polyethylene glycol, and polypropylene glycol. Non-limiting examples of suitable alicyclic diols include 1,2-cyclohexanedimethanol, 1,3-cyclohexanedimethanol, 1,4-cyclohexanedimethanol, and 2,2,4,4-tetramethyl-1,3-cyclobutanediol. Non-limiting examples of suitable aromatic diols include ethylene oxide adducts of bisphenol compounds such as 2,2-bis(4′β-hydroxyethoxydiphenyl)propane and bis(4′-β-hydroxyethoxyphenypsulfone, and xylylene glycol.

In one embodiment, the polyester comprises 50 mole % of the difunctional alcohol and 50 mole % of the dicarboxylic acid, i.e., a 1:1 mole ratio of difunctional alcohol to dicarboxylic acid. In embodiments, where the glycol-modified polyester is derived from more then one difunctional alcohol, the total mole percent of difunctional alcohol is 50%, and the percent of each difunctional alcohol may be selected as desired for a particular purpose or intended use including to adjust the properities of the glycol-modified polyester. In one embodiment, the glycol-modified polyester is derived from a first difunctional alcohol in an amount of 0.1 to 49.9 mole % and a second difunctional alcohol in an amount of 49.9 to 0.1 mole %. In one embodiment, the glycol-modified polyester is derived from a first difunctional alcohol in an amount of 1 to 49 mole % and a second difunctional alcohol in an amount of 49 to 1 mole %. In one embodiment, the glycol-modified polyester is derived from a first difunctional alcohol in an amount of 5 to 45 mole % and a second difunctional alcohol in an amount of 45 to 5 mole %. In one embodiment, the glycol-modified polyester is derived from a first difunctional alcohol in an amount of 10 to 40 mole % and a second difunctional alcohol in an amount of 40 to 10 mole %. In one embodiment, the glycol-modified polyester is derived from a first difunctional alcohol in an amount of 25 mole % and a second difunctional alcohol in an amount of 25 mole %. It will be appreciated that a glycol-modified polyester is not limited to such embodiments and may comprise more than two difunctional alcohol components to provide a total difunctional alcohol content of 50 mole %. Here as elsewhere in the specification and claims, numerical values may be combined to create new or non-disclosed ranges.

In one embodiment, the modified polyester is a glycol-modified polyethylene terephthalate (PETG). A glycol-modified polyethylene terephthalate may be made by condensing terephthalic acid with a difunctional alcohol other than ethylene glycol, or two or more types of difunctional alcohols (where one of the two or more difunctional alcohols may be ethylene glycol). In one embodiment, a PETG is made by condensing terephthalic acid with ethylene glycol and cyclohexane dimethenol. In another embodiment, the glycol-modified polyester employs a dimethyl terephthalic acid.

Examples of suitable materials for the modified PETG include, but are not limited to, modified PETG resins available from Eastman including those sold under the trade names EASTAR, Eastman SPECTAR, Eastman EMBRACE, etc.

The modified polyester may be thermoplastic. The modified polyester may be substantially amorphous, or may be partially crystalline (semi-crystalline). The modified polyester may have a crystallinity of at least about, and/or at most about, any of the following weight percentages: from about 5 to about 50%, from about 10 to about 40%, from about 15 to about 35%, even from about 20 to about 30%. In one embodiment, the modified polyester has a crystallinity of about 25%. Here as elsewhere in the specification and claims, individual ranges can be combined or modified to form additional or non-disclosed ranges. The crystallinity may be determined indirectly by the thermal analysis method, which uses heat-of-fusion measurements made by differential scanning calorimetry (“DSC”). All references to crystallinity percentages of a polymer, a polymer mixture, a resin, a film, or a layer in this application are by the DSC thermal analysis method, unless otherwise noted. The DSC thermal analysis method is believed to be the most widely used method for estimating polymer crystallinity, and thus appropriate procedures are known to those of skill in the art. See, for example, “Crystallinity Determination,” Encyclopedia of Polymer Science and Engineering, Volume 4, pages 482-520 (John Wiley & Sons, 1986), of which pages 482-520 are incorporated herein by reference. Under the DSC thermal analysis method, the weight fraction degree of crystallinity (i.e., the “crystallinity” or “Wc”) is defined as ΔHf/ΔHf,c where “ΔHf” is the measured heat of fusion for the sample (i.e., the area under the heat-flow versus temperature curve for the sample) and “ΔHf,c” is the theoretical heat of fusion of a 100% crystalline sample. The ΔHf,c values for numerous polymers have been obtained by extrapolation methods; see for example, Table 1, page 487 of the “Crystallinity Determination” reference cited above. The ΔHf,c for polymers are known to, or obtainable by, those of skill in the art. The ΔHf,c for a sample polymer material may be based on a known ΔHf,c for the same or similar class of polymer material, as is known to those of skill in the art. For example, the ΔHf,c for polyethylene may be used in calculating the crystallinity of an EVA material, since it is believed that it is the polyethylene backbone of EVA rather than the vinyl acetate pendant portions of EVA, that forms crystals. Also by way of example, for a sample containing a blend of polymer materials, the ΔHf,c for the blend may be estimated using a weighted average of the appropriate ΔHf,c for each of the polymer materials of separate classes in the blend. The DSC measurements may be made using a thermal gradient for the DSC of 10° C./minute. The sample size for the DSC may be from 5 to 20 mg.

The skin layers may comprise one or more regular polyesters, one or more modified polyesters, or combinations of two or more thereof. In one embodiment, the skin layers comprise a blend of at least two different modified polyesters. Modified polyesters may be different from one another in terms of the respective components that form the polyester or, if comprising the same components, in terms of the percentage of each component in the respective modified polyesters. In one embodiment, the skin layers comprise at least one PETG material. In another embodiment the skin layers comprise a blend of at least two PETG materials. In one embodiment, the skin layers comprise a blend of a regular polyester and a glycol-modified polyester. In one embodiment, the skin layers individually comprise PET, PETG, or a combination of two or more thereof.

The modified polyester resin may have a glass transition temperature (Tg) of from about 50° C. to about 120° C. In one embodiment, the modified polyester resin has a glass transition temperature of from about 60° C. to about 90° C. In still another embodiment, the modified polyester resin has a glass transition temperature of from about 70° C. to about 80° C. It will be appreciated that a blend of two or more modified polyesters will also exhibit a glass transition temperature that may be the same or different than the glass transition temperatures of the individual modified polyesters used to form the blend. Here as elsewhere in the specification and claims, numerical values may be combined to create new or non-disclosed ranges.

The skin layers can comprise from 5 to about 100% by weight of the polyester glycol-modified polyester; from about 10 to about 90% by weight; from about 15 to about 80% by weight; even from about 20 to about 70% by weight. In one embodiment the skin layers comprise from about 50 to about 100% by weight; 60 to about 90% by weight; even from about 70 to about 80% by weight. Here as elsewhere in the specification and claims, numerical values can be combined to form new or non-disclosed ranges.

### Tie Layers

The tie layers comprise a material suitable for adhering the skin layers to the core layer(s). In one embodiment, the tie layers individually comprise a molecular structure with a pendant or terminal group capable of anchoring dissimilar materials, e.g., to anchor a skin layer to the core where the skin layer and the core are dissimilar and would not exhibit sufficient adhesion to one another. Non-limiting examples of suitable tie layers include anhydride modified materials, alkoxysilane materials, etc. In one embodiment, the tie layers comprise an anhydride modified material. The inventors have found that anhydride modified materials provide good adhesion between the skin layers comprising a glycol-modified polyester and the core layer comprising a polyolefin. Additionally, the use of such tie layers provides a film that exhibits little or no delamination during shrink.

The anhydride moiety can be derived from any suitable source including, but not limited to, polymer or resin material comprised units derived from one or more of the following monomers: maleic anhydride, itaconic anhydride, dimethyl maleic anhydride, nadic anhydride, nadic methyl anhydride, tetrahydrophthalic anhydride, 4-methyl cyclohex-4-ene-1,2-dicarboxylic anhydride, bicyclo(2.2.2)oct-5-ene-2,3-dicarboxylic anhydride, bicyclo(2.2.1)hept-5-ene-2,3-dicarboxylic anhydride, tetrahydrophthalic anhydride, norborn-5-ene-2,3-dicarboxylic anhydride, and methylbicyclo(2.2.1)hept-5-ene-2,3-dicarboxylic anhydride or combinations of two or more thereof. In a particularly suitable embodiment, the polymer contains units derived from a carboxylic acid anhydride monomers, most preferably maleic anhydride monomers.

The anhydride modified material is not particularly limited. In one embodiment, the anhydride modified material is an anhydride modified ethylene copolymer. The ethylene co-polymer can comprise comonomer units derived from acrylic acid, alkyl acrylic acid, vinyl acetate, or an alpha-olefin. In one embodiment, the ethylene copolymer is an anhydride modified ethylene acrylate copolymer. An example of a suitable ethylene acrylate copolymer is ethylene methacrylate (EMA). In another embodiment, the ethylene copolymer is an anhydride modified ethylene vinyl acetate.

In one embodiment, the tie layers can comprise an anhydride-grafted copolymer of ethylene and higher olefins. Ethylene copolymers can 25 contain up to as much as 40 percent by weight comonomer but more typically will have comonomer contents less than about 25 weight percent. The higher olefin comonomers can be an olefin having 3 or more carbon atoms. Ethylene homopolymers produced by low pressure methods which are linear high density polyethylene (HDPE) resins or branched low density polyethylene (LDPE) resins produced using high pressure methods provide suitable grafting backbones as do linear low density polyethylenes (LLDPE) obtained by copolymerizing ethylene and alpha-olefins, such as butene-1 or hexene-1.

Several resins suitable for use as tie layers are available commercially under the trademark “Bynel” (Dupont Co.) and “Primacor” (Dow Chemical Co.). Non-limiting examples of suitable materials for the tie layer include, but are not limited to, anhydride-modified ethylene acrylate copolymer such as Bynel 2169, Bynel 2174, Bynel 21E787, Bynel 21E810, or Bynel 21E533 available from DuPont Co.

Non-functionalized ethylene copolymers such as EMA or EVA may be included in the tie layer or substituted for the functionalized ethylene copolymers. In embodiments where the tie layer does not include an anhydride functionalized ethylene copolymer, the stretching ratio of the film should be kept relatively low, e.g., from about 2:1 to about 3:1.

### Additives

The heat shrinkable film can comprise one or more additives to enhance the manufacture and processing of the film and/or the service performance of the film. The monolayer film or each of the layers of the multilayer film can comprise at least one additive. Suitable additives may include, but are not limited to, antiblocking agents, processing aids, nucleating agents, fillers, colorants to include pigments and dyes, antistatic agents, antioxidants, slip agents, ultraviolet stabilizers, and mixtures of two or more of any of the foregoing additives. The additives can be introduced to the film or film layers as a component of a film polymer wherein the additive is blended with a film polymer such as, for example, a nucleated polypropylene polymer, which is a blend of the polymer and a nucleating agent or as an additive concentrate where the additive concentrate comprises the additive and a carrier resin such as, for example, antiblocking agents and processing aids. The skin and core layers can comprise nucleating agents to enhance film stiffness and clarity. The skin layers can comprise surface active additives to facilitate manufacture and processing to include antiblocking agents, processing agents and antistatic agents. Nucleating agents are generally a component of a film polymer such as a nucleated polypropylene film polymer as described hereinabove. Useful antiblocking agents include the antiblock concentrates Ampacet 401960 (Seablock-4) and ABPP05-SC from A. Schulman. Useful processing aids include the processing aid concentrate Ampacet 401198. Each of the additives can be present in the film or a layer of the film on a weight basis of about 0.005% to about 20%, or about 0.01% to about 15%, or about 0.02% to about 10%.

In one embodiment, the core layer can comprise a tackifier such as petroleum resins and terpene resins, so as to exhibit high shrinkability, to exhibit low-temperature shrinkability and toughness, and to prevent natural contraction (spontaneous shrinkage). Exemplary tackifiers include rosin resins such as rosins, polymerized rosins, hydrogenated rosins, and derivatives of them, and resin-acid dimers; terpene resins such as terpene resins, aromatic modified terpene resins, hydrogenated terpene resins, and terpene-phenol resins; and petroleum resins such as aliphatic, aromatic, or alicyclic petroleum resins. Among them, petroleum resins are preferred. Each of the different tackifiers may be used alone or in combination. The amount of tackifiers, if added, can be 30 percent by weight or less (e.g., 10 to 30 percent by weight) based on the total weight of the core layer. Tackifiers in an amount of more than 30 percent by weight may cause excessively increased cost and poor cost effectiveness or may cause the shrink film to be brittle. Tackifiers in an amount of less than 10 percent by weight may not exhibit sufficient advantageous effects. The way to add tackifiers is not particularly limited, and compounding by dry blending or kneading is often employed. As the tackifiers, commercial products such as “ARKON” supplied by Arakawa Chemical Industries, Ltd. are available.

### Adhesives

Optionally, the shrink film may include an adhesive disposed on an outer surface of the film (e.g., on an outer surface of one of the skin layers). A description of useful pressure sensitive adhesives may be found in Encyclopedia of Polymer Science and Engineering, Vol. 13, Wiley-Interscience Publishers (New York, 1988). Additional description of useful PSAs may be found in Polymer Science and Technology, Vol. 1, Interscience Publishers (New York, 1964). Conventional PSAs, including acrylic-based PSAs, rubber-based PSAs and silicone-based PSAs are useful. The PSA may be a solvent based or may be a water based adhesive. Hot melt adhesives may also be used. In one embodiment, the PSA comprises an acrylic emulsion adhesive.

The adhesive and the side of the film to which the adhesive is applied have sufficient compatibility to enable good adhesive anchorage. The adhesive can also be chosen so that the adhesive components do not migrate into the film.

In one embodiment, the adhesive may be formed from an acrylic based polymer. It is contemplated that any acrylic based polymer capable of forming an adhesive layer with sufficient tack to adhere to a substrate may function in the present invention. In certain embodiments, the acrylic polymers for the pressure-sensitive adhesive layers include those formed from polymerization of at least one alkyl acrylate monomer containing from about 4 to about 12 carbon atoms in the alkyl group, and present in an amount from about 35-95% by weight of the polymer or copolymer, as disclosed in U.S. Pat. No. 5,264,532. Optionally, the acrylic based pressure-sensitive adhesive might be formed from a single polymeric species.

The glass transition temperature of a PSA layer comprising acrylic polymers can be varied by adjusting the amount of polar, or “hard monomers”, in the copolymer, as taught by U.S. Pat. No. 5,264,532, incorporated herein by reference. The greater the percentage by weight of hard monomers is an acrylic copolymer, the higher the glass transition temperature. Hard monomers contemplated useful for the present invention include vinyl esters, carboxylic acids, and methacrylates, in concentrations by weight ranging from about zero to about thirty-five percent by weight of the polymer.

The PSA can be acrylic based such as those taught in U.S. Pat. No. 5,164,444 (acrylic emulsion), U.S. Pat. No. 5,623,011 (tackified acrylic emulsion) and U.S. Pat. No. 6,306,982. The adhesive can also be rubber-based such as those taught in U.S. Pat. No. 5,705,551 (rubber hot melt). It can also be radiation curable mixture of monomers with initiators and other ingredients such as those taught in U.S. Pat. No. 5,232,958 (UV cured acrylic) and U.S. Pat. No. 5,232,958 (EB cured). The disclosures of these patents as they relate to acrylic adhesives are hereby incorporated by reference.

Commercially available PSAs are useful in the invention. Examples of these adhesives include the hot melt PSAs available from H.B. Fuller Company, St. Paul, Minn. as HM-1597, HL-2207-X, HL-2115-X, HL-2193-X. Other useful commercially available PSAs include those available from Century Adhesives Corporation, Columbus, Ohio. Another useful acrylic PSA comprises a blend of emulsion polymer particles with dispersion tackifier particles as generally described in Example 2 of U.S. Pat. No. 6,306,982. The polymer is made by emulsion polymerization of 2-ethylhexyl acrylate, vinyl acetate, dioctyl maleate, and acrylic and methacrylic comonomers as described in U.S. Pat. No. 5,164,444 resulting in the latex particle size of about 0.2 microns in weight average diameters and a gel content of about 60%.

A commercial example of a hot melt adhesive is H2187-01, sold by Ato Findley, Inc., of Wauwatusa, Wis. In addition, rubber based block copolymer PSAs described in U.S. Pat. No. 3,239,478 also can be utilized in the adhesive constructions of the present invention, and this patent is hereby incorporated by a reference for its disclosure of such hot melt adhesives that are described more fully below.

In another embodiment, the pressure-sensitive adhesive comprises rubber based elastomer materials containing useful rubber based elastomer materials include linear, branched, grafted, or radial block copolymers represented by the diblock structure A-B, the triblock A-B-A, the radial or coupled structures (A-B)ₙ, and combinations of these where A represents a hard thermoplastic phase or block which is non-rubbery or glassy or crystalline at room temperature but fluid at higher temperatures, and B represents a soft block which is rubbery or elastomeric at service or room temperature. These thermoplastic elastomers may comprise from about 75% to about 95% by weight of rubbery segments and from about 5% to about 25% by weight of non-rubbery segments.

The non-rubbery segments or hard blocks comprise polymers of mono- and polycyclic aromatic hydrocarbons, and more particularly vinyl-substituted aromatic hydrocarbons that may be monocyclic or bicyclic in nature. Rubbery materials such as polyisoprene, polybutadiene, and styrene butadiene rubbers may be used to form the rubbery block or segment. Particularly useful rubbery segments include polydienes and saturated olefin rubbers of ethylene/butylene or ethylene/propylene copolymers. The latter rubbers may be obtained from the corresponding unsaturated polyalkylene moieties such as polybutadiene and polyisoprene by hydrogenation thereof.

The block copolymers of vinyl aromatic hydrocarbons and conjugated dienes that may be utilized include any of those that exhibit elastomeric properties. The block copolymers may be diblock, triblock, multiblock, starblock, polyblock or graftblock copolymers. Throughout this specification, the terms diblock, triblock, multiblock, polyblock, and graft or grafted-block with respect to the structural features of block copolymers are to be given their normal meaning as defined in the literature such as in the Encyclopedia of Polymer Science and Engineering, Vol. 2, (1985) John Wiley & Sons, Inc., New York, pp. 325-326, and by J. E. McGrath in Block Copolymers, Science Technology, Dale J. Meier, Ed., Harwood Academic Publishers, 1979, at pages 1-5.

Such block copolymers may contain various ratios of conjugated dienes to vinyl aromatic hydrocarbons including those containing up to about 40% by weight of vinyl aromatic hydrocarbon. Accordingly, multi-block copolymers may be utilized which are linear or radial symmetric or asymmetric and which have structures represented by the formulae A-B, A-B-A, A-B-A-B, B-A-B, (AB)_{0,1,2} . . . BA, etc., wherein A is a polymer block of a vinyl aromatic hydrocarbon or a conjugated diene/vinyl aromatic hydrocarbon tapered copolymer block, and B is a rubbery polymer block of a conjugated diene.

The block copolymers may be prepared by any of the well-known block polymerization or copolymerization procedures including sequential addition of monomer, incremental addition of monomer, or coupling techniques as illustrated in, for example, U.S. Pat. Nos. 3,251,905; 3,390,207; 3,598,887; and 4,219,627. As well known, tapered copolymer blocks can be incorporated in the multi-block copolymers by copolymerizing a mixture of conjugated diene and vinyl aromatic hydrocarbon monomers utilizing the difference in their copolymerization reactivity rates. Various patents describe the preparation of multi-block copolymers containing tapered copolymer blocks including U.S. Pat. Nos. 3,251,905; 3,639,521; and 4,208,356, the disclosures of which are hereby incorporated by reference.

Conjugated dienes that may be utilized to prepare the polymers and copolymers are those containing from 4 to about 10 carbon atoms and more generally, from 4 to 6 carbon atoms. Examples include from 1,3-butadiene, 2-methyl-1,3-butadiene(isoprene), 2,3-dimethyl-1,3-butadiene, chloroprene, 1,3-pentadiene, 1,3-hexadiene, etc. Mixtures of these conjugated dienes also may be used.

Examples of vinyl aromatic hydrocarbons which may be utilized to prepare the copolymers include styrene and the various substituted styrenes such as o-methylstyrene, p-methylstyrene, p-tert-butylstyrene, 1,3-dimethylstyrene, alpha-methylstyrene, beta-methylstyrene, p-isopropylstyrene, 2,3-dimethylstyrene, o-chlorostyrene, p-chlorostyrene, o-bromostyrene, 2-chloro-4-methylstyrene, etc.

Many of the above-described copolymers of conjugated dienes and vinyl aromatic compounds are commercially available. The number average molecular weight of the block copolymers, prior to hydrogenation, is from about 20,000 to about 500,000, or from about 40,000 to about 300,000.

The average molecular weights of the individual blocks within the copolymers may vary within certain limits. In most instances, the vinyl aromatic block will have a number average molecular weight in the order of about 2000 to about 125,000, or between about 4000 and 60,000. The conjugated diene blocks either before or after hydrogenation will have number average molecular weights in the order of about 10,000 to about 450,000, or from about 35,000 to 150,000.

Also, prior to hydrogenation, the vinyl content of the conjugated diene portion generally is from about 10% to about 80%, or from about 25% to about 65%, particularly 35% to 55% when it is desired that the modified block copolymer exhibit rubbery elasticity. The vinyl content of the block copolymer can be measured by means of nuclear magnetic resonance.

Specific examples of diblock copolymers include styrene-butadiene (SB), styrene-isoprene (SI), and the hydrogenated derivatives thereof. Examples of triblock polymers include styrene-butadiene-styrene (SBS), styrene-isoprene-styrene (SIS), alpha-methylstyrene-butadiene-alpha-methylstyrene, and alpha-methylstyrene-isoprene alpha-methylstyrene. Examples of commercially available block copolymers useful as the adhesives in the present invention include those available from Kraton Polymers LLC under the KRATON trade name.

Upon hydrogenation of the SBS copolymers comprising a rubbery segment of a mixture of 1,4 and 1,2 isomers, a styrene-ethylene-butylene styrene (SEBS) block copolymer is obtained. Similarly, hydrogenation of an SIS polymer yields a styrene-ethylene propylene-styrene (SEPS) block copolymer.

The selective hydrogenation of the block copolymers may be carried out by a variety of well known processes including hydrogenation in the presence of such catalysts as Raney nickel, noble metals such as platinum, palladium, etc., and soluble transition metal catalysts. Suitable hydrogenation processes which can be used are those wherein the diene-containing polymer or copolymer is dissolved in an inert hydrocarbon diluent such as cyclohexane and hydrogenated by reaction with hydrogen in the presence of a soluble hydrogenation catalyst. Such procedures are described in U.S. Pat. Nos. 3,113,986 and 4,226,952, the disclosures of which are incorporated herein by reference. Such hydrogenation of the block copolymers which are carried out in a manner and to extent as to produce selectively hydrogenated copolymers having a residual unsaturation content in the polydiene block of from about 0.5% to about 20% of their original unsaturation content prior to hydrogenation.

In one embodiment, the conjugated diene portion of the block copolymer is at least 90% saturated and more often at least 95% saturated while the vinyl aromatic portion is not significantly hydrogenated. Particularly useful hydrogenated block copolymers are hydrogenated products of the block copolymers of styrene-isoprene-styrene such as a styrene-(ethylene/propylene)-styrene block polymer. When a polystyrene-polybutadiene-polystyrene block copolymer is hydrogenated, it is desirable that the 1,2-polybutadiene to 1,4-polybutadiene ratio in the polymer is from about 30:70 to about 70:30. When such a block copolymer is hydrogenated, the resulting product resembles a regular copolymer block of ethylene and 1-butene (EB). As noted above, when the conjugated diene employed as isoprene, the resulting hydrogenated product resembles a regular copolymer block of ethylene and propylene (EP).

A number of selectively hydrogenated block copolymers are available commercially from Kraton Polymers under the general trade designation “Kraton G.” One example is Kraton G1652 which is a hydrogenated SBS triblock comprising about 30% by weight of styrene end blocks and a midblock which is a copolymer of ethylene and 1-butene (EB). A lower molecular weight version of G1652 is available under the designation Kraton G1650. Kraton G1651 is another SEBS block copolymer which contains about 33% by weight of styrene. Kraton G1657 is an SEBS diblock copolymer which contains about 13% w styrene. This styrene content is lower than the styrene content in Kraton G1650 and Kraton G1652.

### Shrink Films

The thickness of the film and the respective core and skin layers can be chosen as desired for a particular purpose or intended use. The film can have a thickness in one embodiment, from about 10 to about 400 microns. In another embodiment, the film can have a thickness of from about 20 to about 300. In another embodiment, the film can have a thickness of from about 30 to about 150 microns. In one embodiment, the shrink film has a thickness of about 40 microns. In another embodiment, the shrink film has a thickness of about 50 microns. Here, as elsewhere in the specification and claims, individual numerical values can be combined to form additional and/or non-disclosed ranges.

The core layer can have a thickness as desired for a particular purpose or intended use. In one embodiment, the core layer can have a thickness of from about 10 to 300 microns; from about 15 to about 250 microns, from about 25 to about 200 mils, from about 50 microns to about 150 microns, etc. Here as elsewhere in the specification and claims, individual ranges may be combined or modified to form additional and/or non-disclosed ranges. In one embodiment, the core layer has a thickness of from about 10 to about 30 microns. In embodiments, the core can be relatively thick compared to the outer skin layers. In one embodiment, the core layer can be about 2 to 20 times as thick as each of the skin layers.

The skin layers may have a thickness as desired for a particular purpose or intended use. In one embodiment, the skin layers can have a thickness of from about 2 to 50 microns, from about 10 to about 40 microns, from about 15 to about 30 microns, etc. Here as elsewhere in the specification and claims, individual ranges can be combined or modified to form additional and/or non-disclosed ranges. In one embodiment, the skin layers have a thickness of from about 5 to about 10 microns.

The tie layers can have a thickness as desired for a particular purpose or intended use. In one embodiment, the tie layers can have a thickness of from about 1 to 10 microns, from about 2 to about 7 microns, from about 3 to about 5 microns, etc. Here as elsewhere in the specification and claims, individual ranges can be combined or modified to form additional and/or non-disclosed ranges.

In embodiments, the thickness ratio of the core to the outer layers combined is 95:5, 90:10, 80:20, 70:30, etc. In one embodiment, the thickness ratio upper skin layer:core:lower skin layer is 2.5-35:95-30:35-2.5, or in another embodiment, 5-15:70-90:15-5. In embodiments, the thickness ratio for the shrink films include 2.5:95:2.5, 5:90:5, 10:80:10, 15:70:15, 20:60:20, etc. The two skin layers do not have to be of equal thickness. Other embodiments of thickness ratios for the shrink films include 2.5:92.5:5, 5:92.5:2.5, 15:75:10, 10:75:15, 5:85:10, 10:85:5. Here as elsewhere in the specification and claims, individual numerical values can be combined to form additional and/or non-disclosed ranges.

As described above, the shrink films are useful in many shrink film applications. The films may be converted to a label by adding a pressure sensitive adhesive to one side of the film. Print indicia may be placed onto either side of the film prior to adding a pressure sensitive adhesive or back-printed prior to applying the adhesive.

The adhesive may be any of those known to those skilled in the art. The pressure sensitive adhesive may be any solvent or emulsion based pressure sensitive adhesive such as acrylic or rubber based pressure sensitive adhesives. Typically, the adhesive is placed onto the film at a coat weight of about 10 to about 40, or from about 20 to about 25 grams/m². An example of a particularly useful adhesive is S2001 available from Avery Chemicals.

The films and labels can be provided with or without a release liner as may be desired for a particular purpose or intended use. The use of a liner may be employed to protect the film and any adhesive layer during shipping and to prevent the film from unintentionally adhering to itself or to a substrate prior to application of the film to a desired substrate. The construction of the release liner is not particularly limited and can be chosen as desired for a particular purpose or intended use.

The film may be manufactured by film-forming processes known in the art. The film may be prepared by extrusion or co-extrusion utilizing, for example, a tubular trapped bubble film process, a flat or tube cast film process, or a slit die flat cast film process. The film may also be prepared by applying one or more layers by extrusion coating, adhesive lamination, extrusion lamination, solvent-borne coating, or by latex coating (e.g., spread out and dried on a substrate). A combination of these processes may also be employed. These processes are known to those of skill in the art.

It will be appreciated that the shrink films are oriented in at least one direction. The film may be oriented in either the machine (i.e., longitudinal), the transverse direction, or in both directions (i.e., biaxially oriented), for example, to enhance the strength, optics, and durability of the film. A web or tube of the film may be uniaxially or biaxially oriented by imposing a draw force at a temperature where the film is softened (e.g., above the vicat softening point; see ASTM 1525) and for example at a temperature below the film's melting point. The film may then be quickly cooled to retain the physical properties generated during orientation and to provide a heat-shrink characteristic to the film. The film may be oriented using, for example, a tenter-frame process or a bubble process. The orientation may occur in any of one direction (i.e., the machine or transverse direction) and/or two directions (e.g., the machine and transverse directions) by a ratio of about 1.1:1 to about 4:1, about 1.2:1 to about 3.8:1, about 1.5:1 to about 3.5:1, about 1.8:1 to about 3.2:1, even about 2:1 to about 3:1. The film may be stretched by any of these amounts in one direction and another of any of these amounts in another direction.

The film may have a free shrink at 100° C. in one direction (e.g., the machine direction or the transverse direction) and/or in both the machine and transverse directions of about, 5% to about 80%, about 7% to about 75%, about 9% to about 70%, about 10% to about 60%, about 12% to about 55%, about 15 to about 50%, about 25% to about 45%, even about 30% to about 40%. In one embodiment, the film has a free shrink of at least about 40% in at least one direction. In another embodiment, the film has a free shrink of at least about 50% in one direction. In a further embodiment, the film has a free shrink of at least about 60% in one direction. In still another embodiment, the film has a free shrink of at least about 70% in one direction. Here as elsewhere in the specification and claims, individually ranges may be combined to form additional or non-disclosed ranges. The film may have any of the forgoing shrink amounts in the machine and/or transverse directions at temperatures ranging from about 40 to about 90° C., or about 50 to about 70° C. For example, the film may have a free shrink at 80° C. in the transverse direction of at least about 60% and a free shrink at 60° C. in the machine direction of at most about 10%. Also, the film may have any combination of the forgoing shrink values at differing temperatures; for example, the film may have a free shrink at 90° C. in at least one direction of at least about 75% and a free shrink at 70° C. in any direction of at most about 5%. The film may be annealed, for example, to decrease the shrink attribute at a selected temperature (e.g., 70° C.).

In one embodiment, the shrink film has a dimensional change in the machine direction (MD shrink) of from about 30% to about 55%; from about 35% to about 50%; even from about 40% to about 45%. In one embodiment, the film exhibits a shrink characteristic in the machine direction, and the film exhibits a growth (or expansion) (TD growth) in the transverse direction of no more than about 10%; no more than about 7%; no more than about 5%. In one embodiment, the film exhibits a TD growth of 0 to 10%; about 0.5% to about 7%; even about 1% to about 5%. Here as elsewhere in the specification and claims, numerical values can be combined to form new and non-disclosed ranges.

In one embodiment, the film has a shrink profile such that the film exhibits a shrinkage in at least one direction, and at least about 50% of the total shrinkage takes place within a temperature range T1 above the onset temperature of the film. The temperature range over which this occurs can be referred to herein as the “shrink window.” In one embodiment, the shrink onset temperature of the film is the temperature (or temperature range) at which the film begins to shrink and exhibits a shrink of about 2% or less. In another embodiment, the shrink onset temperature of the film is the temperature (or temperature range) at which the film begins to shrink and exhibits a shrink of about 1% or less. In one embodiment the shrink film has an onset temperature between about 60° C. and about 80° C. In another embodiment, the shrink film has an onset temperature of about 60° C. to about 70° C. In still another embodiment, the film has an onset temperature for shrink of about 75° C. or greater, about 80° C. or greater, about 85° C. or greater, even about 90° C. or greater. Here as elsewhere in the specification and claims, numerical values can be combined to form new and non-disclosed ranges.

In one embodiment, a shrink film exhibits a total shrink (which can also be referred to as the final shrink percentage), and the film has a shrink window T1, where the film exhibits a shrinkage of about 50% to about 90% of the total shrink. In one embodiment, film has a shrink window where the film exhibits a shrinkage of about 60% to about 80% of total shrink, even a shrinkage of about 65% to about 75% of the total shrink. Here as elsewhere in the specification and claims, numerical values can be combined to form new and non-disclosed ranges. The total shrink or final shrink percentage can be determined as the point at which the film does not exhibit any significant dimensional change upon further heating of the film.

In one embodiment, the film exhibits a shrink of about 30% to about 50% within the shrink window. In one embodiment, the shrink window T1 is from about 15° C. to about 40° C. above the onset temperature of the film. at a temperature of about 15° C. to about 40° C. above the onset temperature. In one embodiment, the film exhibits a shrink of about 30% to about 50% at a temperature of about 40° C. above the onset temperature. In one embodiment, the film exhibits a shrink of about 30% to about 50% at a temperature of about 30° C. above the onset temperature. In one embodiment, the film exhibits a shrink of about 30% to about 50% at a temperature of about 15° C. above the onset temperature. Here as elsewhere in the specification and claims, numerical values can be combined to form new and non-disclosed ranges.

The film may be annealed or heat-set to slightly or substantially reduce the free shrink of an oriented film, for example to raise the shrink initiation temperature. The film may have less than about any of 3%, 2%, and 1% free shrink in any direction at temperatures between 40 and 65° C. The free shrink of the film is determined by measuring the percent dimensional change in a 10×10 cm film specimen when subjected to selected heat (i.e., at a specified temperature exposure) according to ASTM D 2732, which is incorporated herein in its entirety by reference. All references to free shrink in this application are measured according to this standard. In one embodiment, the labels of the present invention may be prepared by co-extruding an upper skin layer, core layer and lower skin layer such as those described above.

The films have sufficient strength to be printed by flexographic and gravure printing. These films generally have a Young's modulus from about 50,000 to about 600,000 psi; from about 150,000 to about 500,000 psi; from about 175,000 to about 400,000 psi; or from about 200,000 to about 300,000 psi. In one embodiment, the film has a modulus of greater than about 300,000 psi. Young's modulus is determined by ASTM D 882.

In one embodiment, the film has relatively low shrink force. As used herein, the “shrink force” refers to the amount of force a film exerts per unit area on its cross-section during shrink. In one embodiment, the film has a shrink force of about 75 to about 900 psi; from about 100 psi to about 800 psi; from about 200 psi to about 600 psi; from about 300 psi to about 500 psi. Here as elsewhere in the specification and claims, numerical values can be combined to form new and non-disclosed ranges.

The film can be subjected to post processing steps after manufacture. In one embodiment, the films may be subjected to corona discharge. Irradiating the films can increase the modulus of the film, reduce the shrink force of the film, or both, as compared to the modulus or shrink force of a film prior to irradiating the film.

In one embodiment, the film begins to degrade, soften, or change dimensions at a temperature T2, which is generally above the maximum temperature of T1. The film can exhibit a shrink profile with a generally flat change in shrinkage between the upper end of T1 and T2. Cross-linking the film increase the life of the film and delay degradation of the film by increasing T2. Cross-linking may be accomplished by chemical cross-linking or irradiating the film or any particular layers amenable to being cross-linked.

The film may have a printed image applied to it, for example, by any suitable ink printing method, such as rotary screen, gravure, or flexographic techniques. The printed image may be applied to a skin layer. The printed image may be applied as a reverse printed image, for example, applied to the inside layer of the film of a shrink sleeve. This film is then printed by gravure printing and transfer laminated to a pressure sensitive adhesive on a release liner such as the silicone treated paper.

In one embodiment, the upper skin layer contains print indicia thereon. In one embodiment, the lower skin layer contains print indicia thereon. In one embodiment, the upper skin layer contains an adhesive layer thereon. In one embodiment, the lower skin layer contains an adhesive layer thereon. In one embodiment, the upper skin layer contains print indicia and an adhesive layer thereon. In one embodiment, the lower skin layer contains print indicia and an adhesive layer thereon.

The labels are particularly useful in encapsulating articles such as batteries. By way of illustration, the shrink film may be laminated to a pressure sensitive adhesive with liner. The film is die cut to form individual labels and the matrix surrounding the labels are removed. The resulting labels are then applied to a battery and then shrink wrapped in a heat tunnel. The temperature of the heat tunnel is approximately 250-260° F. The labels of the present invention encapsulate the battery as well without end puckering. When using these labels to encapsulate batteries, it is also understood that the labels may further include circuitry such as that used to determine the strength of the battery charge. Circuitry may be internal of the label, e.g., on the adhesive side of the label or on the outer surface of the label such as circuitry which would then be further covered with another film such as those described above, or a varnish to protect it from damage. Encapsulates for batteries and methods for encapsulating batteries along with description of some circuitry for battery labels is described in U.S. Pat. No. 5,190,609, issued to Lin et al. This patent in incorporated by reference for those teachings.

### Example Embodiments

In one embodiment, the film comprises a five layer structure having a polyolefin core and polyolefin skin layers. In one embodiment, the film comprises a five layer structure comprising a linear low density polyethylene core layer, tie layers disposed about the core comprising linear low density polyethylene, and skin layers disposed about the tie layers comprising polypropylene. In another embodiment, the film comprises a five layer structure comprising a linear low density polyethylene core layer, tie layers disposed about the core comprising EVA, and skin layers disposed about the tie layers comprising polypropylene.

In one embodiment, the film comprises a five layer structure comprising a core layer comprising a polyolefin, and skin layers comprising a polyester material. In one embodiment, the film comprises a linear low density polyethylene core layer, tie layers disposed about the core comprising an anhydride modified material (e.g., EMA), and skin layers disposed about the tie layers comprising a regular polyester, a glycol-modified polyester, or a combination thereof.

The above embodiments are only examples of possible embodiments of a film in accordance with aspects of the invention and are not intended to limit the scope of the invention.

While the invention has be described with reference to various exemplary embodiments, it will be appreciated that modifications may occur to those skilled in the art, and the present application is intended to cover such modifications and inventions as fall within the spirit of the invention.

What is claimed is:

1. A shrink film comprising a plurality of layers and exhibiting a shrink onset temperature, wherein the film exhibits a total shrink and at least about 50% of the total shrink occurs within a temperature range T1 above the onset temperature of the film.

2. The shrink film of claim 1, wherein the film exhibits a shrinkage of from about 50% to about 90% of the total shrink within the temperature range T1.

3. The shrink film of claim 1, wherein the film exhibits a shrinkage of from about 60% to about 80% of the total shrink within the temperature range T1.

4. The shrink film of claim 1, wherein T1 is from about 15° C. to about 40° C. above the onset temperature.

5. A shrink film comprising a plurality of layers and exhibiting a shrink onset temperature, wherein the film exhibits a shrink in at least one direction of at least 30% at a temperature of about 15° C. to about 40° C. above the onset temperature.

6. The shrink film of claim 5, wherein the film exhibits a shrink of about 30% to about 50% within a temperature of about 15° C. to about 40° C. above the onset temperature.

7. The shrink film of claim 5, wherein the film exhibits a shrink of about 30% to about 50% within a temperature of about 40° C. above the onset temperature.

8. The shrink film of claim 5, wherein the film exhibits a shrink of about 30% to about 50% within a temperature of about 30° C. above the onset temperature.

9. The shrink film of claim 1, wherein the film exhibits a shrink of about 30% to about 50% within a temperature of about 15° C. above the onset temperature.

10. The shrink film of claim 1, wherein the onset temperature is from about 60° C. to about 80° C.

11. The shrink film of claim 1, wherein the film comprises a core layer having an upper surface and a lower surface; a first skin layer disposed about the upper surface of the core layer; a second skin layer disposed about the lower surface of the core layer; a first tie layer disposed between the first skin layer and the upper surface of the core layer; and a second tie layer disposed between the second skin layer and the lower surface of the core layer.

12. The shrink film of claim 11, wherein the core layer comprises an amorphous material, a semi-crystalline material, or a combination thereof.

13. The shrink film of claim 11, wherein the core layer comprises a semi-crystalline material having a crystallinity of about 1 to about 80%

14. The shrink film of claim 11, wherein the wherein the first and second skin layers individually comprise a polyester material, and the tie layers individually comprise an anhydride modified material.

15. The shrink film of claim 14, wherein the polyester material is chosen from a regular polyester, a glycol modified polyester, or a combination thereof.

16. The shrink film of claim 11, wherein the core layer comprises a polyolefin material.

17. The shrink film of claim 11, wherein at least one layer of the film is amenable to cross-linking and such layer comprises a chemical cross-linking agent or is subjected to irradiation.

18. The shrink film of claim 1, wherein the film has a MD shrink of about 30% to about 55%.

19. The shrink film of claim 1, wherein the film has a modulus of from about 50,000 to about 600,000 psi.

20. The shrink film of claim 1, wherein the film has a modulus of about 300,000 psi or greater.

21. The shrink film of claim 1, wherein the film has a shrink force of about 75 to about 900 psi.

22. The shrink film of claim 1, wherein the film has a TD growth of about 0 to about 10%.

23. A shrink film comprising
a core layer having an upper surface and a lower surface;
a first skin layer disposed about the upper surface of the core layer;
a second skin layer disposed about the lower surface of the core layer;
a first tie layer disposed between the first skin layer and the upper surface of the core layer; and
a second tie layer disposed between the second skin layer and the lower surface of the core layer, wherein the first and second skin layers individually comprise a polyester material, and the tie layers individually comprise an anhydride modified material.

24. The shrink film of claim 23, wherein the anhydride modified material is chosen from an anhydride modified polyolefin material, an anhydride modified ethylene copolymer, or a combination thereof.

25. The shrink film of claim 24, wherein the anhydride modified ethylene copolymer is chosen from an ethylene acrylate copolymer, an ethylene vinyl acetate copolymer, ethylene alpha-olefin copolymer, or a combination of two or more thereof.

26. The shrink film of claim 23, wherein the anhydride modified material comprises an anhydride ethylene methacrylate polymer.

27. The shrink film of claim 23, wherein the polyester is chosen from a regular polyester resin, a glycol-modified polyester resin, or a combination thereof.

28. The shrink film of claim 27, wherein the glycol-modified polyester is a glycol-modified polyethylene terephthalate.

29. The shrink film of claim 23, wherein the polyester material is chosen from PET, PETG, or a combination thereof.

30. The shrink film of claim 23, wherein the core layer comprises a polyolefin.

31. The shrink film of claim 23, wherein the core layer comprises a low density polyethylene polymer.

32. The shrink film of claim of claim 23, wherein the core layer comprises linear low density polyethylene; the skin layers individually comprise PET, a PETG, or a combination thereof; and the tie layers individually comprise an anhydride modified ethylene methacrlyate.

33. The shrink film of claim 23, wherein the film has a MD shrink of about 30% to about 55%.

34. The shrink film of claim 23, wherein the film has a modulus of from about 50,000 to about 600,000 psi.

35. The shrink film of claim 23, wherein the film has a modulus of about 300,000 psi or greater.

36. The shrink film of claim 23, wherein the film has a shrink force of about 75 to about 900 psi.

37. The shrink film of claim 23, wherein the film has a TD growth of about 0 to about 10%.

38. The shrink film of claim 23, wherein the film is machine direction oriented, transverse direction oriented, or a combination thereof.

39. An article encapsulated with the shrink film of any of claims 23-38.

40. The article of claim 39, wherein the article is a battery.

41. A method of making a shrink film comprising forming a plurality of film layers to provide a film structure having a core layer having an upper surface and a lower surface; a first skin layer disposed about the upper surface of the core layer; a second skin layer disposed about the lower surface of the core layer; a first tie layer disposed between the first skin layer and the upper surface of the core layer; and a second tie layer disposed between the second skin layer and the lower surface of the core layer, wherein the first and second skin layers individually comprise a polyester, and the tie layers individually comprise an anhydride modified material.

42. The method of claim 41, wherein the method comprises co-extrusion of the respective layers.

43. The method of claim 41 comprising forming a sheet, orienting the sheet by stretching in the machine direction, the transverse direction, or both, and (a) irradiating the sheet prior to orientation, (b) irradiating the film following subsequent to orientation, or both (a) and (b).
